(19) United States
(12) Patent Application Publication
(10) Pub. No.: US 2024/0316912 A1
(43) Pub. Date: Sep. 26, 2024

(54) STACK OF A TISSUE PAPER PRODUCT INCLUDING NON-WOOD FIBRES

(71) Applicant: Essity Hygiene and Health Aktiebolag, Goteborg (SE)

(72) Inventors: Mohamed Ali CHARFEDDINE, Kunheim (FR); Emmanuelle KIENTZ, Kunheim (FR); Agne BUOB, Kunheim (FR); Hans-Jürgen LAMB, Mannheim (DE)

(21) Appl. No.: 18/577,421

(22) PCT Filed: Jul. 9, 2021
(86) PCT No.: PCT/SE2021/050714

§ 371 Date: Jan. 8, 2024

(51) Int. Cl. B32B 29/02; B32B 29/00

(52) U.S. Cl. CPC B32B 29/02; B32B 29/005; B32B 2250/26; B32B 2262/062; B32B 2307/54; B32B 2307/718; B32B 2307/72; B32B 2307/726; B32B 2307/7376; B32B 2555/00

(57) ABSTRACT

A stack of tissue paper product, wherein the tissue paper product is forming panels having a length, and a width perpendicular to said length, said panels being piled on top of each other to form a stack height, said tissue paper product comprising at least one non-wood tissue ply, the non-wood tissue ply comprising non-wood pulp fibres being present in an amount of at least 10% by dry weight of the of the non-wood tissue ply, the stack having a density of at least 0.12 g/cm3.

### CROSS REFERENCE TO RELATED APPLICATIONS

This application is a National Stage application of PCT/SE2021/050714, filed Jul. 9, 2021, which is incorporated by reference in its entirety herein.

### TECHNICAL FIELD

The present disclosure relates to a stack of a tissue paper product including an amount of non-wood fibres.

### BACKGROUND

Tissue paper materials find extensive use in modern society. Toilet paper, and paper towels such as hand towels or household (kitchen) towels, facial tissues, tissue handkerchiefs, napkins, and industrial wipes are staple items of commerce. These products are typically made from papermaking pulp including wood fibres, such as hardwood and softwood fibres.

In the following, a “tissue paper product” relates to an absorbent paper product based on cellulose wadding which is also called tissue paper material or tissue paper base-sheet in this field of technology.

Tissue paper material is defined as a soft absorbent paper material having a low basis weight, of for example 8 to 45 g/m², preferably 10 to 35 g/m² per ply. The total basis weight of multi-ply tissue paper products may preferably be up to a maximum of 110 g/m², more preferably to a maximum of 80 g/m². Its density is typically below 0.6 g/cm³, preferably below 0.30 g/cm³ and more preferably in the range of 0.02 g/cm³ and 0.20 g/cm³. The production of tissue paper material is distinguished from conventional paper production, e.g. printing paper production, by its relatively low basis weight and relatively high tensile energy absorption index (see ISO 12625-4). Conventional paper and tissue paper also differ in general with regard to the modulus of elasticity that characterises the stress/strain properties of these generally planar products as a material parameter.

The fibres contained in the tissue paper are mainly cellulosic fibres, such as pulp fibres from chemical pulp (e.g. Kraft or sulphite), or mechanical pulp (e.g. ground wood, thermo mechanical pulp, chemo-mechanical pulp and/or chemo-thermo-mechanical pulp/CTMP). Pulps derived from both deciduous (hardwood) and coniferous (softwood) can be used. Fibres may also come from non-wood plants e.g. cereal, bamboo, jute, or sisal. The fibres or a portion of the fibres may be recycled fibres, which may belong to any or all of the above categories. The fibres can be treated with additives, e.g. fillers, softeners, such as, but not limited to, quaternary ammonium compounds and binders, conventional dry-strength agents, temporary wet strength agents or wet-strength agents, in order to facilitate the original paper making or to adjust the properties thereof.

Tissue paper products in particular for use as hygiene- or wiping products primarily include all kinds of tissue paper materials including dry-creped tissue paper material, wet-creped tissue paper material, NTT(flat), TAD-paper material (Through Air Drying), tissue paper material based on structured or textured technologies such as ATMOS, NTT (textured), UCTAD, eTAD, QRT, PrimeLineTEX etc. and cellulose or pulp-wadding, or combinations, laminates or mixtures thereof. Typical properties of these hygiene- and wiping products include the ability to absorb tensile stress energy, their drapability, good textile-like flexibility, properties which are frequently referred to as bulk softness, a high surface softness and a high specific volume with a perceptible thickness. A liquid absorbency as high as possible and, depending on the application, a suitable wet and dry strength as well as an appealable visual appearance of the outer product's surfaces are desired. These properties, among others, allow these hygiene and wiping products to be used, for example, as cleaning wipes such as windscreen cleaning wipes, industrial wipes, kitchen paper or the like; as sanitary products such as for example bathroom tissue, handkerchiefs, household towels, towels and the like; as cosmetic wipes such as for example facials and as serviettes or napkins, just to mention some of the products that can be used. Furthermore, the hygiene- and wiping products can be dry, moist, wet, printed or pre-treated in any manner. In addition, the hygiene- and wiping products may be folded, interleaved or individually placed, stacked or rolled, connected or not, in any suitable manner.

The products described above can be used for personal and household use as well as commercial and industrial use. They are adapted to absorb fluids, remove dust, and for other cleaning purposes.

If tissue paper material is to be made out of pulp, the process essentially includes a forming step that includes a headbox- and a forming wire section, and a drying section, e.g. including through air drying or conventional drying on a Yankee cylinder. The production process can also include a crepe process for tissue paper and, finally, typically a monitoring and winding area.

Tissue paper material can be formed by placing the fibres, in an oriented or random manner, on one or between two endless continuously rotating wires or felts of a paper making machine while simultaneously removing water.

Further dewatering and drying the formed primary fibrous web occur in one or more steps by mechanical and thermal means until a final dry-solid content of usually about 90 to 99% has been reached.

In case of creped tissue paper material making, this stage is followed by the crepe process which influences the properties of the finished tissue paper product in conventional processes. The conventional dry crepe process involves creping on a usually 3.0 to 6.5 m diameter drying cylinder, the so-called Yankee cylinder, by means of a crepe doctor blade with the aforementioned final dry-solids content of the raw tissue paper. Wet creping can be used as well, if lower demands are made of the tissue quality. The creped, finally dry raw tissue paper material, the so-called base tissue, is then available for further processing into the tissue paper product.

Instead of the conventional tissue making process described above, the use of a modified technique is possible in which an improvement in specific volume is achieved by a special kind of drying which leads to an improvement in the e.g. caliper, bulk, softness, etc. of the tissue paper material. This process, which exists in a variety of subtypes, is herein generally termed the structured tissue technique. Examples of structured tissue techniques are TAD ATMOS®, NTT (textured), UCTAD, eTAD, QRT, PrimeLineTex etc.

The processing step from the tissue paper material to the finished tissue paper product occurs in processing machines (converting machines) which include operations such as unwinding the tissue paper material (base tissue), calendering of the tissue, laminating, printing or embossing.

Several plies may be combined together by a combining operation of a chemical nature (e.g. by adhesive bonding), or of a mechanical nature (e.g. by knurling or so-called edge-embossing), or a combination of both. Examples of such process steps for combining plies together will be described in more detail in the below.

Further, the processing to finished tissue paper product may involve e.g. longitudinal cut, folding, cross cut etc. Moreover, individual tissue paper products may be positioned and brought together to form stacks, which may be individually packaged. Such processing steps may also include application of substances like scents, lotions, softeners or other chemical additives.

When several plies are combined together using adhesive bonding, a film of adhesive is deposited over some or all of the surface of at least one of the plies, then the adhesive-treated surface is placed in contact with the surface of at least one other ply.

When several plies are combined together using mechanical bonding, the plies may be combined by knurling, by compression, by edge-embossing, union embossing and/or ultrasonic.

Mechanical and adhesive bonding may also be combined to combine several plies together to form a multi-ply product.

Embossing is to change the shape of a sheet from flat to shaped, so that there are areas that are raised and/or recessed from the rest of the surface. It therefore constitutes a deformation of the previously relatively flat sheet, and results in a ply having a particular relief. The thickness of the ply or of the multiple plies is in most cases increased after embossing compared with its initial thickness.

An embossing process is carried out between an embossing roll and an anvil roll. The embossing roll can have protrusions or depressions on its circumferential surface leading to embossed protrusions/depressions in the paper web. Anvil rolls may be softer than the corresponding embossing roll and may consist of rubber, such as natural rubber, or plastic materials, paper or steel. If the anvil roll is made of a softer material like rubber, a contact area/nip can be formed between the embossing roll (e.g. steel roll) and the anvil roll by the deformation of the softer roll.

By embossing, a pattern can be applied to a tissue paper fulfilling a decorative and/or functional purpose.

A functional purpose may be to improve the properties of the hygiene paper product, that is, the embossment may improve the product thickness, absorbency, bulk, softness etc.

A functional purpose may also be to provide a joint to another ply in a multi-ply product.

Tissue paper products display a number of physical properties which are of importance for their use for example as toilet paper, hand towels, kitchen towels, facial tissues, handkerchiefs, napkins, wipe or the like. Examples of such properties are their strength, softness, and absorbency (primarily for aqueous systems). These physical properties are generally tuned for addressing common consumer demand in view of the intended use of the tissue paper product.

For example, tissue paper products need to retain their strength at least for a time period of use e.g. for wiping liquids or moisture.

At the same time, there are requirements regarding tactile properties such as softness as tissue paper products may be intended to come in intimate contact with the body and skin. Accordingly, it is desired that tissue paper products shall exhibit sufficient softness in order to ensure consumer's comfort.

However, some of the desired physical properties of tissue paper products are generally conflicting properties. One example is strength and softness. Often, as strength in a tissue paper product rises, the softness declines.

Hence, it is desired to provide a tissue paper product providing a good balance between required properties. For example, it is desired to provide a tissue paper product achieving a satisfactory balance between softness and strength.

Further, there is a desire to reduce the consumption of wood fibre to produce tissue paper products. This desire is advocated by e.g. rising costs for wood fibre, concerns involving sustainable forest management, and other environmental reasons such as carbon foot print.

To this end, attempts have been made to replace some or all of the wood fibre in tissue paper products with for example recycled fibres and/or with non-wood fibres. However, since the fibre content in the pulp will naturally impact the above-mentioned physical properties of the resulting tissue paper material, the replacement of virgin wood fibres with other fibres in the pulp is not uncomplicated.

This applies not only to the product of tissue paper materials per se, but also the converting, handling and/or storage of the tissue paper products. When subject to procedures which may involve e.g. folding, compressing or loading the tissue paper products, tissue paper products including non-wood fibre and/or recycled fibres have been found to behave differently than conventional products using virgin wood fibre. To fulfil the need for replacing some or all of the wood fibre in tissue paper products with for example recycled fibres and/or with non-wood fibres, it is therefore necessary to find solutions for the tissue paper products handling and storage, ensuring the function of the tissue paper products also after e.g. packaging.

Thus, there is a need for improvement and/or alternatives for tissue paper products in view of one or more of the above-mentioned desires.

### SUMMARY

An object of the present invention is to fulfill said need for improvement and/or alternatives.

To this end, it is proposed herein to use non-wood cellulose pulp fibres in tissue paper materials and tissue paper products.

The non-wood cellulose pulp fibres may be chemical pulp fibres.

Optionally, the non-wood cellulose pulp fibres may be never-dried fibres. “Never-dried” means herein that the fibres have not been subject to drying before use in the tissue making process. It is believed that the non-wood cellulose pulp fibres being never-dried may contribute to the non-wood cellulose pulp fibres being suitable for use in tissue paper materials and tissue paper products.

Optionally, the non-wood cellulose pulp fibres contain at least 15% hemicellulose. It is believed that such a hemicellulose content may contribute to the non-wood cellulose pulp fibres being suitable for use in tissue paper materials and tissue paper products.

Optionally, the non-wood cellulose pulp fibres contain no more than 15% lignin. For example, the non-wood cellulose pulp fibres may contain no more than 12% lignin. In yet another example, the non-wood cellulose pulp fibres may contain no more than 10% lignin. It is believed that such a lignin content may contribute to the non-wood cellulose pulp fibres being suitable for use in tissue paper materials and tissue paper products.

For example, the non-wood cellulose pulp fibres may contain at least 15% hemicellulose and no more than 15% lignin, such as no more than 12% lignin or no more than 10% lignin.

Optionally, the non-wood cellulose pulp fibres are pre-treated, to obtain the desired amounts of lignin and/or hemicellulose.

Further, the non-wood cellulose pulp fibres may have a relatively low average fibre length.

Optionally, the non-wood cellulose pulp fibres have an average fibre length of less than 1700 μm.

Optionally, the non-wood cellulose pulp fibres have an average fibre length of less than 1200 μm.

Optionally, the non-wood cellulose pulp fibres have an average fibre length of less than 1000 μm.

Optionally, the non-wood cellulose pulp fibres have an average fibre length of less than 900 μm.

Further, it is believed that the non-wood cellulose pulp fibres having a relatively high breaking length may contribute to the non-wood cellulose pulp fibres being suitable for use in tissue paper materials and tissue paper products. The breaking length is the initial breaking length of the non-wood cellulose pulp fibres as measured on the non-wood cellulose pulp fibres after the pulping process.

Optionally, the non-wood cellulose fibres have a breaking length of more than 3000 m.

For example, the non-wood cellulose fibres may have a breaking length of more than 3000 m and an average fibre length of less than 1700 μm, such as less than 1200 μm or less than 900 μm.

Also, it is believed that the non-wood cellulose pulp fibres having a relatively high ratio between breaking length and average fibre length may contribute to the non-wood cellulose pulp fibres being suitable for use in tissue paper materials and tissue paper products.

Optionally, the non-wood cellulose fibres have a breaking length/average fibre length of more than 3.7.

Optionally, the non-wood cellulose fibres have a breaking length/average fibre length ratio of more than 4.0.

Optionally, the non-wood cellulose fibres have a breaking length/average fibre length ratio of more than 4.5.

For example, the non-wood cellulose fibres may have a breaking length/average fibre length ratio of more than 5 such as more than 5.5.

For example, the non-wood cellulose fibres may have a breaking length/average fibre length ratio of more than 3.7 such as more than 4 and an average fibre length of less than 1700 μm, such as less than 1200 μm, less than 1000 μm, or less than 900 μm.

For comparison, it may be mentioned that different types of conventional hardwood and softwood pulps display lower breaking length/average fibre length ratios than those suggested in the above for the non-wood cellulose fibres. This applies also to examples of never-dried hardwood and softwood pulps. Average ratios as calculated for different types of hardwood and softwood pulps are indicated in the table in the below.

| Type of pulps | Average ratio |
|---|---|
| BEK | 2.4 |
| BHK | 2.0 |
| BSK | 1.0 |
| BSS | 0.6 |
| NBHK | 2.3 |
| NBSK | 1.2 |
| Never-dried HW | 0.9 |
| Never-dried SW | 1.0 |

(BEK—Bleached Eucalyptus Pulp, BHK—Bleached Hardwood Kraft, BSK—Bleached Softwood Kraft, BSS—Bleached Softwood Sulfite, Northern Bleached Hardwood Kraft, Northern Bleached Softwood Kraft. The never-dried Hardwood (HW) and Softwood (SW) are sulfite.)

Also, several types of previously used non-wood cellulose pulp fibres have been found to display lower breaking length/average fibre length ratio than what is proposed in the above. For example, tested samples of dried bagasse fibre pulp was found to have an average ratio of 2.6, dried bamboo fibre pulp an average ratio of 1.2 and dried wheat fibre pulp an average ratio of 3.5.

For example, the non-wood cellulose fibres may be never-dried non-wood cellulose pulp fibres and the non-wood cellulose fibres may have a breaking length/average fibre length ratio of more than 3.7, such as more than 4.0 or more than 4.5.

The non-wood cellulose pulp fibres as proposed herein may be used together with hardwood cellulose pulp fibres and/or softwood cellulose pulp fibres.

As mentioned in the above, optionally, a portion of or all non-wood cellulose pulp fibres are never-dried non-wood cellulose pulp fibres.

Optionally, the non-wood cellulose fibres are used with softwood cellulose pulp fibres. In this case, a portion of or all softwood cellulose fibres may be never-dried softwood cellulose pulp fibres.

For example, the softwood cellulose pulp fibres may include never-dried hardwood cellulose pulp fibres and/or dried softwood cellulose pulp fibres.

Optionally, the non-wood cellulose fibres are used with hardwood cellulose pulp fibres. In this case, a portion of or all hardwood cellulose fibres may be never-dried hardwood cellulose pulp fibres.

For example, the hardwood cellulose pulp fibres may include never-dried hardwood cellulose pulp fibres and/or dried hardwood cellulose pulp fibres.

Optionally, the non-wood cellulose pulp fibres as proposed herein may be achieved by treatment by a non-pressurised process.

Optionally, the non-wood cellulose pulp fibres as proposed herein may be achieved by treatment by a process with no use of sulfur.

For example, the non-wood cellulose pulp fibres may be achieved by treatment using methods similar to the methods described EP 2 048281 A1, EP 2 247781 B1, US20130129573 A1, EP 2 034 090 A1, US20110281298 A1, and/or US20130129573 A1.

Additionally or alternatively, the non-wood cellulose pulp fibres may be achieved by treatment using methods similar to the methods described in WO2020264311 A1, WO2020264322 A1, US20190091643 A1, U.S. Pat. No. 2,592,983.

For example, the non-wood cellulose pulp fibres may be achieved by the Phoenix Process™, of Sustainable Fiber Technologies Inc.

It will be understood that the features as discussed in the above as being contributing to the non-wood cellulose pulp fibres being suitable for use in tissue paper materials and tissue paper products may be used separately or in different combinations.

Optionally, the non-wood cellulose pulp fibres are derived from agricultural waste or byproduct.

Optionally, the non-wood cellulose pulp fibres are derived from a member of the Pocacea family. For example, the non-wood cellulose pulp fibres may be derived from wheat straw, rice straw, barley straw, oat straw, rye grass, costal Bermuda grass, Arundo donax, miscanthus, bamboo, and/or sorghum. Another example of a member of the Pocacea family is sugar cane, from which non-wood cellulose pulp fibres may be derived, for example from sugar cane bagasse.

Optionally, the non-wood cellulose pulp fibres are derived from a member of the Cannabaceae family. For example, the non-wood cellulose pulp fibres may be derived from hemp and/or hop.

Optionally, the non-wood cellulose pulp fibres are derived from agricultural waste or byproducts. For example, the non-wood cellulose pulp fibres may be derived from agricultural waste or byproducts of the members of the Pocacea family and/or Cannabaceae family such as exemplified in the above, i.e. including agricultural waste or byproducts from wheat straw, rice straw, barley straw, oat straw, rye grass, bagasse from sugar cane, hemp or hop. In another example, the non-wood cellulose pulp fibres may be derived from agricultural waste or byproducts such as banana harvest residue (belongs to the family Musaceae), pineapple residue (belongs to the family Bromeliaceae), nut shell waste, bagasse from agave, hop residue and/or corn stover.

Optionally, the non-wood cellulose pulp fibres are derived from kenaf (belongs to the family Malvaceae), switchgrass, succulents, alfalfa (belongs to the family Fabaceae), flax straw (belongs to the family Linaceae), palm fruits (Elaeis or Arecaceae), and/or avocado (Lauraceae).

Optionally, the non-wood cellulose pulp fibres are derived from one or more of wheat straw, rice straw, barley straw, oat straw, rye grass, costal Bermuda grass, Arundo donax, miscanthus, bamboo, sorghum, banana harvest residue, pineapple residue, nut shell waste, sugar cane bagasse, industrial hemp, and/or members of the Cannabaceae family, kenaf, switchgrass, succulents, alfalfa, corn stover, and flax straw.

Optionally, the non-wood cellulose pulp fibres are derived from wheat straw, oat straw, barley straw, and/or rye grass. For example, the non-wood cellulose pulp fibres may be derived from agricultural waste or byproducts of wheat straw, oat straw, barley straw, and/or rye grass.

For example, the non-wood cellulose pulp fibres may be derived from wheat straw, such as from agricultural waste or byproducts of wheat.

Optionally, the non-wood cellulose pulp fibres are derived from residues from sugar production. For example, the non-wood cellulose pulp fibres may be residues from beet.

Optionally, the non-wood cellulose pulp fibres are derived from sugarcane bagasse.

Optionally, the non-wood cellulose pulp fibres are derived from agave. For example, the non-wood cellulose pulp fibres may be derived from resides from agave syrup production or derived from agave bagasse.

Although the present disclosure relates primarily to tissue paper made of non-wood fibres, it is understood that the non-wood cellulose pulp fibres as described herein may also find use in other applications e.g. in wound care, in absorbent articles, for example diapers, sanitary napkins, and incontinence articles, in beauty care, and/or in nonwoven materials and products.

Herein, the non-wood cellulose pulp fibres as described in the above are proposed to be used to form a non-wood tissue ply, including non-wood cellulose pulp fibres in an amount of at least 10% by dry weight of the non-wood tissue ply.

Optionally, said non-wood tissue ply includes non-wood cellulose pulp fibres in an amount of at least 15% by dry weight of the non-wood tissue ply.

Optionally, said non-wood tissue ply includes non-wood cellulose pulp fibres in an amount of at least 20% by dry weight of the non-wood tissue ply.

Optionally, said non-wood tissue ply includes non-wood cellulose pulp fibres in an amount of at least 30% by dry weight of the non-wood tissue ply.

Optionally, said non-wood tissue ply includes non-wood cellulose pulp fibres in an amount of at least 40% by dry weight of the non-wood tissue ply.

Optionally, said non-wood tissue ply includes non-wood cellulose pulp fibres in an amount from 20 to 50% by dry weight of the non-wood tissue ply.

Optionally, said non-wood tissue ply includes non-wood cellulose pulp fibres in an amount from 25 to 35% by dry weight of the non-wood tissue ply.

Optionally, said non-wood tissue ply includes non-wood cellulose pulp fibres in an amount of less than 70% by dry weight of the non-wood tissue ply.

Optionally, said non-wood tissue ply includes non-wood cellulose pulp fibres in an amount of less than 60% by dry weight of the non-wood tissue ply.

Optionally, the non-wood tissue ply further includes wood pulp fibres, such as hardwood cellulose pulp fibres and/or softwood cellulose pulp fibres.

Optionally, the non-wood tissue ply further includes wood pulp fibres in an amount such that the wood pulp fibre amount plus the non-wood fibre amount constitutes 100% dry weight of the tissue paper ply.

Optionally, the hardwood/softwood dry weight proportion of the wood pulp fibres in the non-wood tissue ply is less than 95/5.

Optionally, the hardwood/softwood dry weight proportion of the wood pulp fibres in the non-wood tissue ply is less than 90/10.

Optionally, the hardwood/softwood dry weight proportion of the wood pulp fibres in the non-wood tissue ply is less than 80/20.

Optionally, said non-wood cellulose pulp fibres are present throughout the non-wood tissue ply. In other words, at least some non-wood cellulose pulp fibres may be found in all parts of the ply, e.g. in all layers of the ply. The non-wood cellulose pulp fibres need not be uniformly distributed, but may be a result of e.g. stratified distribution of the non-wood cellulose pulp fibres. For example, the non-wood cellulose pulp fibres may be homogenously distributed in the ply. In another example, the non-wood cellulose pulp fibres may be heterogeneously distributed in the ply.

Optionally, when said non-wood tissue ply includes two or more layers, at least one layer of the non-wood tissue ply includes non-wood fibres. For example, said at least one layer maybe an outer layer of the non-wood tissue ply.

Optionally, when said non-wood tissue ply includes two or more layers, each out of said two or more layers may include non-wood fibres.

Optionally, the non-wood tissue ply is produced by conventional wet press technology (CWP). By “is produced” means that the tissue paper material has been manufactured using conventional wet press technology, i.e. the tissue paper material is a CWP tissue paper material. For example, the tissue paper material may be a dry crepe tissue paper material.

Optionally, the non-wood tissue ply is produced by structured tissue technology. By “is produced” means that the tissue paper material has been manufactured using structured tissue technology, i.e. the tissue paper material is a structured tissue paper material.

Optionally, the non-wood tissue ply is produced by TAD (Through Air Drying) technology.

Optionally, the non-wood tissue ply is produced by ATMOS technology.

Optionally, the non-wood tissue ply is produced by UCTAD technology.

Optionally, the non-wood tissue ply is produced by textured NTT technology.

Optionally, the non-wood tissue ply is produced by eTAD technology, such as Advantage eTAD technology from Valmet.

Optionally, the non-wood tissue ply is produced by QRT technology.

Optionally, the non-wood tissue ply is produced by PrimeLine TEX technology.

In accordance with the invention, there is provided tissue paper materials and tissue paper products including the non-wood tissue ply as described in the above with the non-wood cellulose pulp fibres as described in the above.

In accordance with the invention, there is provided a stack of a tissue paper product including the non-wood tissue ply as described in the above with the non-wood cellulose pulp fibres as described in the above.

In accordance with a first aspect of the invention, there is provided a stack according to claim 1. Hence, there is provided a stack of tissue paper product, wherein the tissue paper product is forming panels having a length, and a width perpendicular to said length, said panels being piled on top of each other to form a stack height, said tissue paper product including at least one non-wood tissue ply, the non-wood tissue ply including non-wood pulp fibres being present in an amount of at least 10% by dry weight of the non-wood tissue ply, and the stack having a density of at least 0.12 g/cm3.

It has been found, that a tissue paper product including a non-wood tissue ply including an amount of the non-wood tissue fibres as described in the above, not only may be made to display suitable properties for a tissue paper product, but that these properties may be maintained also after production of a stack of the tissue paper product. The tissue paper product including the non-wood tissue fibres are hence compressible to relatively high densities, without properties such as absorbency or softness being severely affected.

Optionally, as mentioned in the above, the non-wood tissue ply may be made using structured tissue technology. The structured tissue technology used for producing the tissue paper product may, as mentioned in the above, for example be one out of TAD (Through Air Drying), ATMOS, textured NTT, UCTAD, eTAD, QRT and PrimeLine TEX technology.

Optionally, the stack may have a density of at least 0.15 g/cm3.

Optionally, the stack may have a density of at least 0.20 g/cm3.

Optionally, the stack may have a density less than 0.50 g/cm3.

Optionally, the stack may have a density less than 0.40 g/cm3.

For example, the stack may have a density in the range between from 0.20 g/cm3 to 0.40 g/cm3.

For example, the stack may have a density in the range from 0.25 g/cm3 to 0.35 g/cm3.

Optionally, the tissue paper product may be a single-ply product consisting of said non-wood tissue ply.

Alternatively, the tissue paper product may be a multi-ply product including at least two plies, such as three plies, four plies or more plies.

Optionally, when said tissue paper product is a multi-ply product including at least two plies, all of the plies may be non-wood tissue plies as defined in the above. The non-wood tissue plies may include the same amount of non-wood pulp fibres. Alternatively, the non-wood tissue plies may include different amounts of non-wood pulp fibres.

Optionally, the tissue paper product is folded to form the panels of the stack. Thus, the tissue paper product may be in the form of a continuous web, optionally separated by perforation lines, and folded to form the panels in the stack. Alternatively, the tissue paper product may be in the form of separate tissue paper products. The separate tissue paper products may be folded, for example in a two panel fold, a three panel fold or a four panel fold, to form the panels of the stack. Tissue paper products having more than four panels may also be used in the stacks as disclosed herein. Optionally, the separate tissue paper products may be interfolded.

Optionally, the tissue paper product has a basis weight less than 100 gsm.

Optionally, the tissue paper product has a basis weight of less than 80 gsm.

Optionally, the tissue paper product has a basis weight of less than 60 gsm.

Optionally, the tissue paper product has a basis weight of more than 15 gsm.

Optionally, the tissue paper product has a basis weight of more than 20 gsm.

Optionally, the tissue paper product has a GMT tensile strength of at least 60 N/m.

Optionally, the tissue paper product has a GMT tensile strength of at least 70 N/m.

Optionally, the tissue paper product has a GMT tensile strength of at least 80 N/m.

For example, the tissue paper product has a GMT tensile strength of at least 100 N/m.

For example, the tissue paper product has a GMT tensile strength of at least 150 N/m.

For example, the tissue paper product has a GMT tensile strength of at least 200 N/m.

For example, the tissue paper product has a GMT tensile strength of at least 300 N/m.

For example, the tissue paper product has a GMT tensile strength of at least 400 N/m.

Optionally, the tissue paper product has an absorption of at least 7 g/g.

Optionally, the tissue paper product has an absorption of at least 8 g/g.

The absorption may for example be less than 13 g/g. For example, the absorption may be less than 10 g/g.

Optionally, the tissue paper product has a thickness in the range between from 0.1 to 0.8 mm, as obtained after removal of the tissue product from the stack, and with the tissue paper product in an unfolded state.

Optionally, the tissue paper product has a thickness in the range between from 0.1 to 0.6 mm, as obtained after removal of the tissue product from the stack, and with the tissue paper product in an unfolded state.

Optionally, the tissue paper product has a thickness in the range between from 0.1 to 0.3 mm, as obtained after removal of the tissue product from the stack, and with the tissue paper product in an unfolded state.

Optionally, the tissue paper product is a single-ply tissue paper product consisting of a non-wood ply as described in the above.

Optionally, the tissue paper product is a multi-ply tissue paper product including two or more plies, wherein one or more ply is a non-wood ply as described in the above.

The properties of the tissue paper product as set out in the above relates to properties of the unfolded tissue paper product as obtained immediately after the removal from the stack. Measurements may be made after the stack has been stored, for example after storage of the stack for three weeks.

### BRIEF DESCRIPTION OF THE DRAWINGS

With reference to the appended drawings, below follows a more detailed description of embodiments of the invention cited as examples.

In the drawings:

FIG. 1a is a diagram illustrating the dry strength in the machine direction of the tissue paper products from stacks with different non-wood fibre content in relation to the density of the stacks obtained in a first trial;

FIG. 1b is a diagram illustrating the dry strength in the cross direction of the tissue paper products from stacks with different non-wood fibre content in relation to the density of the stacks obtained in the first trial;

FIG. 2 is a diagram illustrating the absorption of the tissue paper products from stacks with different non-wood fibre content in relation to the density of the stacks obtained in the first trial;

FIG. 3 is a diagram illustrating the thickness of the tissue paper products from stacks with different non-wood fibre content in relation to the density of the stacks obtained in the first trial;

FIG. 4 illustrates the force needed to compress the stacks to the different densities for three different tissue paper products with different amount of non-wood fibre content obtained in the first trial;

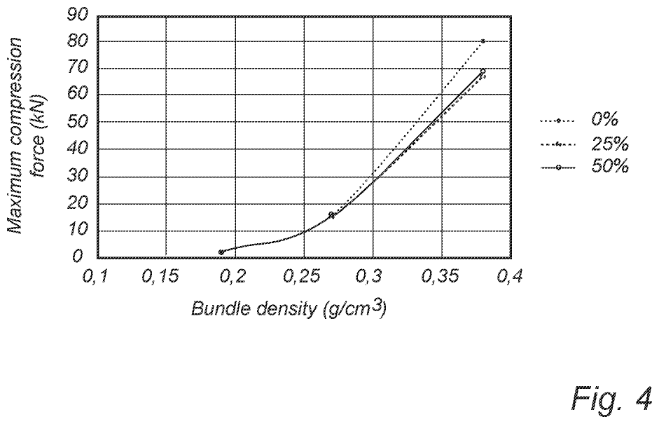

FIG. 5 illustrates the force needed to compress the stacks to the different densities for three different tissue paper products with different amount of non-wood fibre content obtained in a second trial; and

FIG. 6 is a diagram illustrating the thickness of the tissue paper products from stacks with different non-wood fibre content in relation to the density of the stacks after one week of storage of the stacks from the second trial;

FIG. 7 is a diagram similar to the diagram of FIG. 6 but obtained after one month of storage of the stacks from the second trial.

### DETAILED DESCRIPTION

To investigate whether the tissue paper products including the non-wood fibres are suitable for forming stacks, and thereby useful for storage, distribution and dispensing of the tissue paper products, two trials with tissue paper products were performed.

In both trials the tissue paper products were made using structured tissue technology, in this case using ATMOS technology. The tissue paper products were 1 ply products intended for use as hand towels. The basis weight was 30 gsm.

### Pulps

The non-wood fibre pulp was derived from wheat straw, being treated according to the Phoenix™ process by Sustainable Fiber Solutions Inc. The non-wood fibre pulp was never-dried pulp. This type of non-wood fibre pulp generally has lignin content of less than 15% and a hemicellulose content of more than 15%.

The conventional short fibre content was Hardwood cellulose fibre pulp, made fibre of Eucalyptus. The Eucalyptus fibre pulp was dried pulp, BEK (Bleached Eucalyptus Kraft).

The conventional long fibre content was made out of Softwood Cellulose fibre pulp. In this example, the Softwood cellulose fibre pulp was dried pulp, NBSK (Northern bleached softwood kraft).

The non-wood fibre pulp of the first trial and the non-wood fibre pulp of the second trail were slightly different.

The breaking length, average fibre length and breaking length/average fibre length ratio of the non-wood of the first trial (Non-wood (1)), the non-wood of the second trial (Non-wood (2)), the softwood pulp (NBSK) and eucalyptus fibre pulp (BEK) were as indicated in the table below:

| | Non- | Non- | | |
|---|---|---|---|---|
| | wood | wood | | |
| | (1) | (2) | NBSK | BEK |
| Breaking length [m] | 3775 | 5233 | 2915 | 1724 |
| Average fibre length[μm] | 748 | 857 | 2094 | 714 |
| Breaking length/av fibre length | 5.05 | 6.10 | 1.39 | 2.41 |

### Trial 1

1 ply tissue paper materials (base sheets) were made using the above-mentioned pulps for Trial 1, and using ATMOS technology.

Three versions of the tissue paper materials were made.

A first version, including 0% dry weight non-wood fibres.

A second version, including 25% dry weight non-wood fibres.

A third version, including 50% dry weight non-wood fibre.

The non-wood pulp, the softwood pulp and the eucalyptus pulp were blended in pulper with the recipes for the different versions of tissue paper products as indicated in the table in the below, sent to the dump chest and metered to the machine stock system.

| | Variant 1 | Variant 2 | Variant 3 |
|---|---|---|---|
| | 0% Non- | 25% Non- | 50% Non- |
| | wood | wood | wood |
| Softwood Pulp (NBSK) | 60% | 45% | 30% |
| Eucalyptus Pulp (BEK) | 40% | 30% | 20% |
| Non-wood Pulp (1) | 0% | 25% | 50% |

The average properties of the three variants (0%, 25%, 50%) of the tissue paper materials obtained are indicated in the table in the below.

| | | | MD | CD | | MD | CD |
|---|---|---|---|---|---|---|---|
| Amount | Basis | Thick- | dry | dry | MD | wet | wet |
| Non- | weight | ness | (N/ | (N/ | stretch | (N/ | (N/ |
| wood | (g/m²) | (mm) | m) | m) | (%) | m) | m) |
| 0% | 26.5 | 0.23 | 528 | 378 | 19.9 | 130 | 96 |
| 25% | 28.8 | 0.24 | 599 | 525 | 14.9 | 147 | 106 |
| 50% | 29.1 | 0.26 | 651 | 611 | 16 | 138 | 102 |

The tissue paper materials were cut to form separate tissue paper products. The dimensions of the tissue paper products were 22.8 cm×24.1 cm. The tissue paper products were folded in a 3-panel fold and piled on top of each other to form stacks. Each stack included 250 tissue paper products, i.e. 3×250=750 panels.

Five stacks were produced of each one out the first, second and third version of the tissue paper product.

The method of producing the stacks involved compressing the stack to a density higher than a target density of the stack for a predetermined time period, and then releasing the stack to assume said target density.

Each one of the five stacks of each version of the tissue paper product was produced with a different target density.

When producing stacks, more force will be required to compress the tissue paper products with increasing target density of the stacks. The maximum compression force in kN as needed to compress the stacks to the different target densities of the three versions of the tissue paper products is noted in the table below.

| | | |
|---|---|---|
| Bundle density | Final height | Non-wood fibre amount |

| (g/cm³) | (cm) | 0% | 25% | 50% |
|---|---|---|---|---|
| 0.19 | 11.3 | 2.04 | 2.14 | 2.32 |
| 0.27 | 7.9 | 15.81 | 15.40 | 15.09 |
| 0.38 | 5.6 | 80.12 | 67.22 | 69.13 |

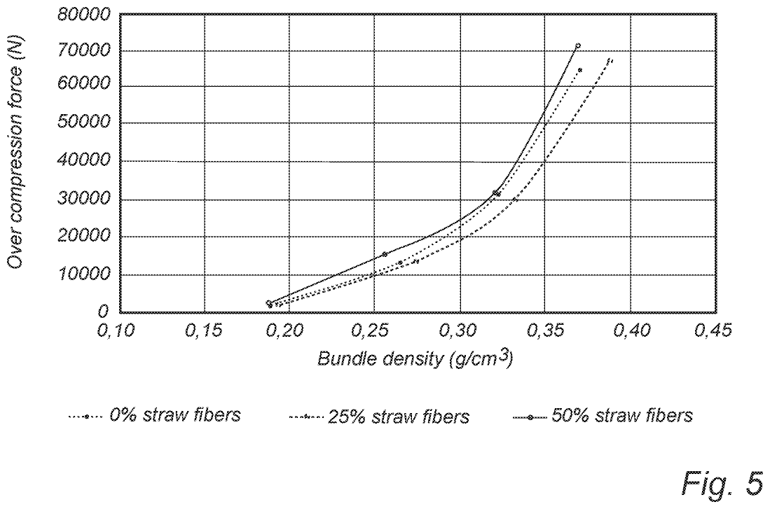

FIG. 5 illustrate the maximum compression force for the three tissue paper product versions over the different stack densities. As may be seen in FIG. 5, the three curves seem to follow approximately the same behavior for densities between 0.19 and about 0.25 g/cm3. For densities greater than 0.25 g/cm3, the curves deviate, such that the compression force required to compress the tissue paper product with 0% non-wood fibre content is greater than the compression force required to compress the tissue paper products with 25% and 50% non-wood fibre content.

The stacks were packaged and then stored within their packaging for 3 weeks.

Then, the packaging was removed and various properties of the tissue paper products from the different stacks were measured.

The results are indicated in the table below:

| Non- | | | Thick- | MD | CD | Absorp- |
|---|---|---|---|---|---|---|
| wood | Density | Grammage | ness | strength | strength | tion |
| amount | g/cm3 | g/m² | mm | N/m | N/m | g/g |
| 0% | 0.13 | 30.3 | 0.24 | 582 | 445 | 8.8 |
| 0% | 0.19 | 29.9 | 0.22 | 569 | 448 | 8.9 |
| 0% | 0.27 | 29.6 | 0.2 | 587 | 426 | 8.4 |
| 0% | 0.32 | 29.3 | 0.19 | 565 | 423 | 8.5 |
| 0% | 0.38 | 29.5 | 0.15 | 591 | 422 | 8.1 |
| 25% | 0.13 | 30.1 | 0.23 | 646 | 510 | 8.9 |
| 25% | 0.19 | 29.9 | 0.21 | 592 | 501 | 8.7 |
| 25% | 0.27 | 29.7 | 0.17 | 627 | 500 | 8.7 |
| 25% | 0.30 | 29.7 | 0.18 | 636 | 513 | 8.5 |
| 25% | 0.38 | 28.4 | 0.15 | 639 | 488 | 8.5 |
| 50% | 0.13 | 30.5 | 0.23 | 637 | 567 | 8.5 |
| 50% | 0.19 | 29.5 | 0.22 | 625 | 540 | 8.8 |
| 50% | 0.27 | 29.0 | 0.2 | 640 | 530 | 8.3 |
| 50% | 0.30 | 29.1 | 0.2 | 655 | 568 | 8.3 |
| 50% | 0.38 | 28.6 | 0.17 | 629 | 527 | 8 |

Thus, the five stacks of Version 1 of the tissue paper material, which contains no non-wood fibre, may be seen as a reference.

In the following, the results of the measurements will be discussed with reference to the drawings.

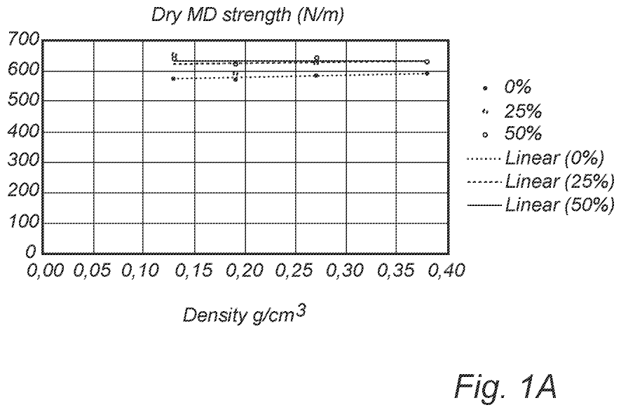

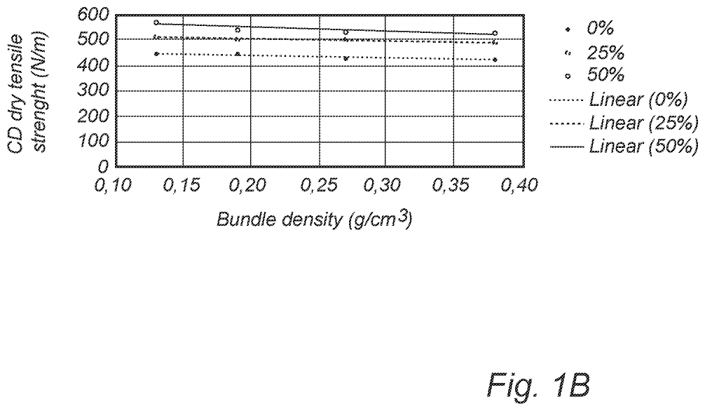

FIG. 1a is a diagram illustrating the dry MD strength of the stacks of different non-wood content and density. As may be seen in FIG. 1a, the Dry MD strength does not vary much between the stack densities ranging between approximately 0.10 and 0.40 kg/dm3. Surprisingly, the stacks of Variant 1, where the tissue paper product includes 0% non-wood fibre displays the lowest dry MD strength for all densities. The diagram shows that the tissue paper products including 25% non-wood fibre or 50% non-wood fibre maintains their dry MD strength after having been compressed to form a stack of the different densities at least as well as the tissue paper product including 0% non-wood fibre.

FIG. 1b is a diagram illustrating the dry CD strength of the stacks of different non-wood content and density. Similar to FIG. 1a, FIG. 1b shows that the tissue paper products including 25% non-wood fibre or 50% non-wood fibre maintains their dry CD strength after having been compressed to form a stack of the different densities at least as well as the tissue paper product including 0% non-wood fibre.

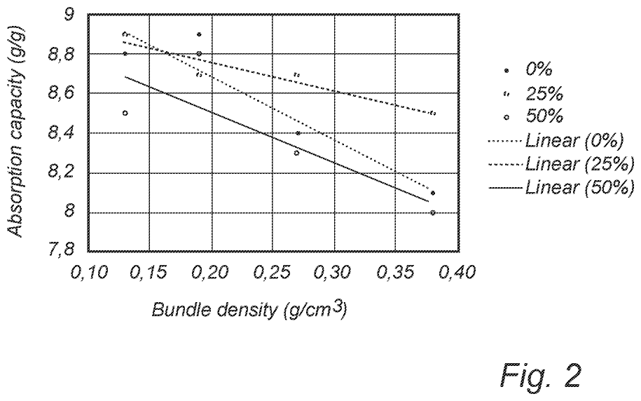

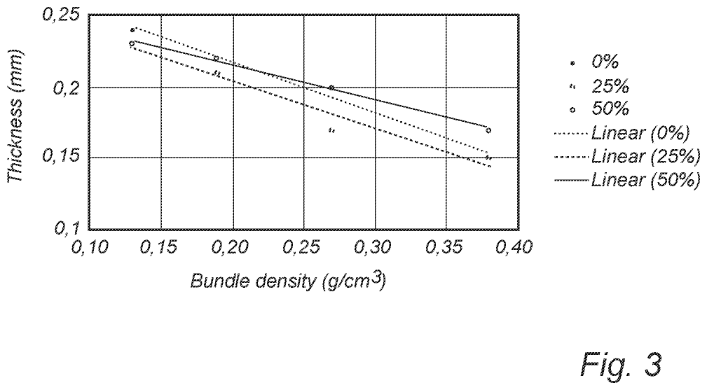

FIG. 2 is a diagram illustrating the absorption of the stacks of different non-wood content and density. Absorption is generally adversely affected by the tissue paper products being compressed into stacks of relatively high density. However, it may be seen from FIG. 3 that the tissue paper products including 25% non-wood fibre or 50% non-wood fibre maintain their absorption after having been compressed to form a stack of the different densities about as well as the tissue paper product including 0% non-wood fibre.

FIG. 3 is a diagram illustrating the thickness of the stacks of different non-wood content and density. Thickness is known to generally be adversely affected by the tissue paper products being compressed into stacks of relatively high density. However, it may be seen from FIG. 3 that the tissue paper products including 25% non-wood fibre or 50% non-wood fibre maintains their thickness after having been compressed to form a stack of the different densities slightly better than the tissue paper product including 0% non-wood fibre.

### Trial 2

1 ply tissue paper materials (base sheets) were made using pulps NBSK, BEK and Non-wood (2) for Trial 2 as described in the above, and using ATMOS technology.

Three versions of the tissue paper materials were made.

A first version, including 0% dry weight non-wood fibres.

A second version, including 25% dry weight non-wood fibres.

A third version, including 50% dry weight non-wood fibre.

The non-wood pulp, the softwood pulp and the eucalyptus pulp were blended in pulper with the recipes for the different versions of tissue paper products as indicated in the table in the below, sent to the dump chest and metered to the machine stock system.

| | Variant 1 | Variant 2 | Variant 3 |
|---|---|---|---|
| | 0% Non- | 25% Non- | 50% Non- |
| | wood | wood | wood |
| Softwood Pulp (NBSK) | 46% | 21% | 0% |
| Eucalyptus Pulp (BEK) | 54% | 54% | 50% |
| Non-wood Pulp (2) | 0% | 25% | 50% |

The average properties of the three variants (0%, 25%, 50%) of the tissue paper materials obtained are indicated in the table in the below.

| | | | MD | CD | | MD | CD |
|---|---|---|---|---|---|---|---|
| Amount | Basis | Thick- | dry | dry | MD | wet | wet |
| Non- | weight | ness | (N/ | (N/ | stretch | (N/ | (N/ |
| wood | (g/m²) | (mm) | m) | m) | (%) | m) | m) |
| 0% | 30.4 | 0.23 | 692 | 479 | 16.07 | 175 | 88 |
| 25% | 31.1 | 0.26 | 579 | 362 | 16.2 | 144 | 67 |
| 50% | 26.0 | 0.27 | 478 | 401 | 15.17 | 86 | 71 |

FIG. 5 illustrates the maximum compression force for the three tissue paper product variants over the different stack densities. In this trial, the two curves for 0% straw fibres and 25% straw fibres seem to follow approximately the same behavior for densities between 0.19 and about 0.25 g/cm3, whereas the curve for 50% straw fibre deviates slightly. For densities greater than 0.25 g/cm3, the curves deviate, such that the compression force required to compress the tissue paper product with 0% non-wood fibre content is greater than the compression force required to compress the tissue paper products with 25% non-wood fibre content. The compression force required to compress the tissue paper products with 50% non-wood fibre content is only slightly higher than the force needed to compress the tissue paper products with 0% non-wood fibre content at densities over about 0.30 g/cm3.

The produced stacks were packaged and stored.

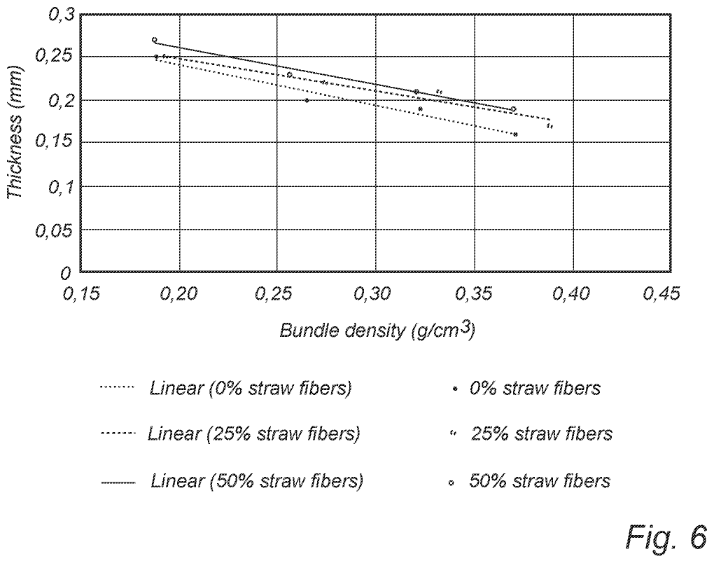

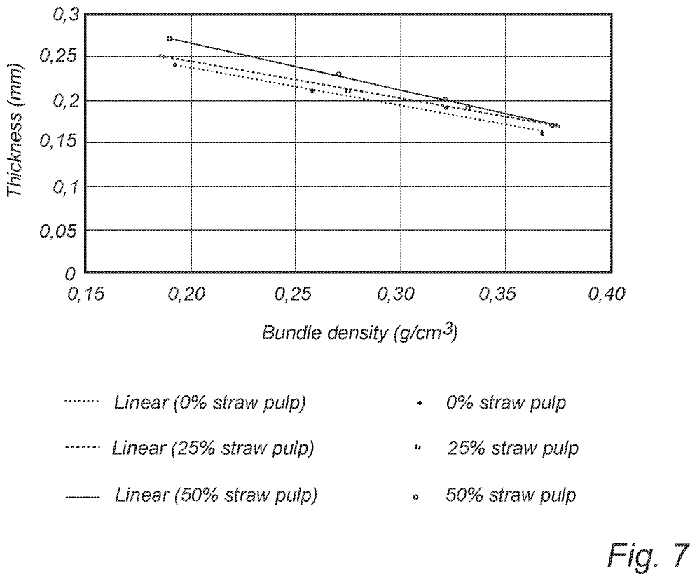

Then, the thickness of the unfolded tissue paper products when removed from the stacks were measured after one week of storage and after one month of storage, as illustrated in FIG. 6 and FIG. 7, respectively.

FIG. 6 is a diagram illustrating the thickness of the stacks of different non-wood content and density after one week of storage. It may be seen from FIG. 6 that the tissue paper products including 25% non-wood fibre or 50% non-wood fibre both maintain their thickness after having been compressed to form a stack of the different densities slightly better than the tissue paper product including 0% non-wood fibre.

FIG. 7 is a diagram illustrating the thickness of the stacks of different non-wood content and density after one month of storage. Again, it may be seen from FIG. 7 that the tissue paper products including 25% non-wood fibre or 50% non-wood fibre both maintain their thickness after having been compressed to form a stack of the different densities slightly better than the tissue paper product including 0% non-wood fibre, also after one month of storage.

### CONCLUSION

In conclusion, for the stacks of different densities including tissue paper products including 25% or 50% non-wood fibres, the measured properties indicate that the tissue paper products from the stacks including non-wood fibres will perform in a manner comparable to the tissue paper product including 0% non-wood fibres, coming from a stack with a similar density.

Thus, in summary, the results indicate that the tissue paper products including non-wood tissue fibres may be formed to stacks with relatively high densities, and that the stacks may be stored without the properties of the tissue paper products falling beyond an acceptable level. Instead, the tissue paper products including the non-wood tissue fibres perform as well as the tissue paper products including no non-wood tissue fibres, after compression to and storage in stacks of similar densities. The benefits for the environment resulting when using non-wood fibres may hence be achieved without requiring adaptation of storage systems, distribution, dispensers or use of the tissue paper products.

Further, in some regards the tissue paper products including the non-wood cellulose pulp fibres perform even better than the tissue paper products without non-wood fibre. For example, the results indicate that with the tissue paper products including non-wood cellulose pulp fibres, stacks with relatively higher densities may be achieved using a relatively lower compression force, if compared to stacks including tissue paper products without non-wood cellulose pulp fibre. This is advantageous in view of production, where relatively lower compression pressures are generally desired in an industrial production line.

### Definitions

Tissue paper material: As tissue paper material we understand herein the one-ply base tissue as obtained from a tissue machine.

Layer: The tissue paper material may include one or more layers, i.e. it may be a single-layered or a multi-layered web. The term “layer” refers to a stratum within the web having a defined fibre composition. The one or more layers is/are formed by depositing one or more streams of pulp furnishes onto a wire with a pressurized single- or multi-layered headbox.

Ply: The term “ply” as used herein refers to the one or more plies of tissue paper material in the final tissue paper product as are obtained after processes, i.e. converting, one or more base tissue webs. Each individual ply consists of a tissue paper material including one or more layers, e.g. one, two, or three layers.

Hardwood: As hardwood we understand herein fibrous pulp derived from the woody substance of deciduous trees (angiosperms). For example, hardwood includes eucalyptus. Typically, hardwood fibres are relatively short fibres. For example, the hardwood fibres may have an average fibre length less than 1700 μm. The hardwood fibres may for example have a diameter of 15 to 40 μm and a wall thickness of 3 to 5 μm.

Softwood: as softwood we understand fibrous pulp derived from the woody substance of coniferous trees (Gymnosperms). Typically, softwood fibres are relatively long fibres. For example, the softwood fibres may have an average fibre length above 1700 μm, such as above 1950 micron, for example the soft wood fibres may have an average fibre length in a range from 1700 to 2500. μm. The softwood fibres may for example have a diameter of from 30 to 80 μm, and a wall thickness of from 2 to 8 μm.

Conventional short fibres: As conventional short fibres we understand herein hardwood fibres as described in the above. Generally, the conventional short fibres may have an average fibre length less than 1700 μm.

Conventional long fibres: As conventional long fibres we understand herein softwood fibres as described in the above. Generally, the conventional long fibres may have an average fibre length greater than 1700 μm.

### CWP & Structured Tissue Technology:

As described in the above, paper tissue webs can be produced in several ways. Conventional paper machines have been used for many years for that purpose, to produce such conventional webs at a relatively low cost.

An example of a conventional paper tissue web process is the dry crepe process which involves creping on a drying cylinder, the so-called yankee cylinder, by means of a crepe doctor. Wet creping can be used as well, if there are lower demands on the tissue quality. The creped, finally dry raw tissue paper, the so-called base tissue, is then available for further processing into the paper product for a tissue paper product.

Recently, more advanced methods have been developed, such as e.g. Through Air Drying (TAD), Advanced Tissue Molding System (ATMOS) and similar methods for producing structured tissue webs. A common feature for these latter methods is that they result in a more structured web with a lower density than a web produced on a conventional paper machine.

As used herein the term CWP technology (Conventional Wet Pressed technology) refers to conventional paper web processes, in which the tissue is formed on a forming fabric and dewatered by pressing with one or more pressure roll nips. The process may involve transfer of the sheet to a Yankee dryer and removing the sheet from the Yankee surface by a doctor blade in a creping process. CWP technology as used herein includes for example dry crepe technology, wet crepe technology, and flat NTT (New Tissue Technology).

As used herein, the term structured tissue technology relates to the newer technologies for producing a structured tissue web. Such methods will not employ the high pressure used to dewater the web in the CWP process. Therefore, structured tissue technology is sometimes referred to as non-compressing de-watering technology. The structured tissue technology may for example be TAD (Thru-Air-Dried), UCTAD (Uncreped-Through-Air-Dried) or ATMOS (Advanced-Tissue-Molding-System), textured NTT, QRT, PrimeLineTEX technology and eTAD technology.

The structured tissue technology methods are known from prior art, for example TAD is known from U.S. Pat. No. 5,853,547; and ATMOS from U.S. Pat. Nos. 7,744,726, 7,550,061 and 7,527,709; and UCTAD from EP 1 156925 and WO 02/40774.

TAD technology has been developed since the 1960's and is well known to a person skilled in the art. It generally involves developing functional properties of the tissue by moulding the fibre mat on a structured fabric. This results in the fibre mat forming a structured tissue which may acquire high bulk and absorption due to air passing through the web while drying the web when still on the structured fabric.

ATMOS technology is a production method developed by Voith and which is also well known to a person skilled in the art.

Another example is textured NTT (New Tissue Technology). Textured NTT was designed to overcome some of the limitations of ATMOS by pressing at even higher pressures before transferring to the Yankee. A shoe press is used in the first pressing section between the former felt and a belt with cells designed to provide absorptive capacity and increase strength. The NTT technology may reduce the Yankee Hood drying load as compared to ATMOS.

Yet other examples are Prime Line Tex technology as rendered available by Andritz for production of textured tissue, and eTAD technology as rendered available by Valmet.

### Methods

Lignin content:

The measurement of residual lignin content in the pulp fibres has been carried out according to the draft standard ISO/DIS 21436: Pulps-Determination of lignin content-Method of acid hydrolysis 1), which includes:
i) the gravimetric measurement of the residue after acid hydrolysis (AIL: Acid Insoluble Lignin or Klason Lignin), also described in the Tappi T222 om-02 method 2; and
ii) the measurement of soluble lignin (ASL: Acid Soluble Lignin), also described in the technical note Tappi UM2503.
3.1) Sample preparation: The samples were disintegrated with a grinder/mixer. Their dry matter contents were determined before analysis, by drying in an oven of an aliquot of 2-3 g at 105° C., according to the ISO 638 standard 4.
3.2) Measurement of acid insoluble lignin (AIL or Klason lignin) after acid hydrolysis An aliquot of ˜1 g was hydrolysed with a solution of sulfuric acid, firstly at ambient temperature (2 h) and then under reflux during 4 h (Procedure B of the future standard). After cooling, the suspension was filtered and washed and the solid residue was collected, dried and weighted. The acid insoluble lignin content in the sample was determined by difference between the dry hydrolysis residue weight and the ash weight, reported to the dry mass content of the initial sample. Note 1: Detection limit (DL) ˜0.1%; Quantification limit (QL) ˜0.5%.
3.3) Measurement of acid soluble lignin. The absorbance at 205 nm of the hydrolysate (i.e. the filtrate collected during the filtration of the suspension, cf 3.2), were measured. The acid soluble lignin content (ASL) was determined according to the predefined extinction coefficient of the lignin (i.e. 110 L/g·cm). Note 2: Detection limit (DL) ˜0.1%
; Quantification Limit (QL) ˜0.5% Remark: This quantification method is sensitive to the contaminants being present into the sample. Each compound other than hemicelluloses and cellulose and the acid insoluble minerals are susceptible to interfere with the measurement of the hydrolysis residue and with the acid soluble lignin.

### Hemicellulose

The determination of the contents of the main polysaccharides in the pulp (arabinane, galactane, glucane, xylene, and mannane) has been made by using high performance anion exchange chromatography with a pulsed amerometric detector,

HPAE/PAD-Dionex® analysis of free monosaccharides (arabinose, galactose, glucose, xylose and mannose) after sulphuric acid hydrolysis of the sample pulp. The cellulose and the hemicellulose content in the pulp sample is determined according to standard method ISO/DIS21437-Pulps: Determination of carbohydrate (under publication) after calibration. The samples studied are chemical pulp which has not required extraction of aceton beforehand. In contrast, the samples have been dried. However, considering the pulp state (wet lap sheets), samples were grinded before analysis. Dry content of the grinded samples was measured according to NF EN ISO 638:2008.

Basically the method is quantifying the amounts of sugars (monosaccharides) after hydrolysis of cellulose and hemi using the ISO/DIS 21437—Pulps: Determination of carbohydrate. Then, calculation is made backwards to estimate level of hemicelluloses (knowing proportion of sugars in hemi and cellulose)

### Basis Weight

Basis weight is determined in accordance with ISO 12625-6: 2016.

The basis weight is determined in g/m2.

### Thickness Per Sheet:

Thickness is determined in accordance with ISO 12625-3.

### Gmt Strength:

GMT strength (Geometric Mean Tensile strength) refers to the square root of the product of the machine direction dry tensile strength and the cross-direction dry tensile strength of a tissue web/product.

The GMT strength is determined in accordance with ISO 12625-4.

A load cell of 100N was used.

### Absorption:

Absorption is herein the water absorption capacity of the tissue paper. Water absorption capacity is the amount of water the sample is able to absorb, reported in g/g (i.e. g water/g material in sample).

Absorption was measured according to ISO12625-8:2011.

The water is deionized water, conductivity≤0.25 mS/m at 25° C., in accordance with ISO14487.

### Average Fibre Length Measurement:

Fibre length measurement was made using the standard for fibre analyser: ISO 16065-2:2014: Pulps-Determination of fibre length by automated optical analysis-Part 1: Unpolarized light method.

Length-weighted mean length was used and the average of the length—weighted fibre-length distribution.

### Breaking Length Measurement

The breaking length is the calculated upper limit of length of a uniform paper strip that would support its own weight if it were suspended at one end. Breaking length (m)=102×T/R, where T=Tensile strength, N/m, and R=basis weight, g/m2.

The breaking length is a pulp characteristic obtained by tensile strength and basis weight measurements as measured on lab handsheets produced in accordance with EN ISO 5269-2. (Tensile strength: ISO 12625-4; basis weight: ISO 12625-6: 2016)

Ratio of breaking length measurement/average fibre length measurement

The ratio of breaking length/average fibre length is herein using the values of the fibre length measurement and the breaking length measurements as achieved according to the methods in the above, the average fibre length measurement being reported in μm, and the breaking length being reported in m.

It may be noted that the breaking length, as well as the average fibre length, are pulp characteristics. Thus the measurements are to be performed on the pulp as received from the pulping process, before reaching the papermaking process, such as before entering the stock preparation in a paper machine. Thus, the measurements are done prior to any mechanical and/or chemical and/or enzymatic treatment for strength adjustment which may occur during the paper making process.

### Density:

Density was determined as weight in g/volume in cm3.

The dimensions of the stack were measured with the stack resting freely on a planar surface. No load was applied to the stack. For the height measurement, the highest point of the stack was measured. The volume of the stack was determined from the measurements.

1. A stack of tissue paper product, wherein the tissue paper product is forming panels having a length, and a width perpendicular to said length, said panels being piled on top of each other to form a stack height, said tissue paper product comprising at least one non-wood tissue ply, the non-wood tissue ply comprising non-wood pulp fibres being present in an amount of at least 10% by dry weight of the non-wood tissue ply, and the stack having a density of at least 0.12 g/cm3.

2. The stack according to claim 1, wherein the non-wood tissue ply is made using structured tissue technology.

3. The stack according to claim 2, wherein said structured tissue technology is one out of TAD (Through Air Drying), ATMOS, textured NTT, eTAD, QRT, UCTAD, and PrimeLineTEX technology.

4. The stack according to claim 1, wherein the stack has a density of at least 0.15 g/cm3.

5. The stack according to claim 1, wherein the stack has a density of at least 0.20 g/cm3.

6. The stack according to claim 1, wherein the stack has a density in the range from 0.20 g/cm3 to 0.40 g/cm3.

7. The stack according to claim 1, wherein the stack has a density in the range from 0.25 g/cm3 to 0.35 g/cm3.

8. The stack according to claim 1, wherein the tissue paper product is a single-ply product consisting of said non-wood tissue ply.

9. The stack according to claim 1, wherein the tissue paper product is a multi-ply product comprising at least two plies, wherein one or more plies is a non-wood tissue ply comprising non-wood pulp fibres being present in an amount of at least 10% by dry weight of the non-wood tissue ply.

10. The stack according to claim 1, wherein said tissue paper product is folded to form said panels of said stack.

11. The stack according to claim 1, wherein the tissue paper product in an unfolded state has a basis weight less than 100 gsm.

12. The stack according to claim 1, wherein the tissue paper product in an unfolded state has a GMT tensile strength of at least 60 N/m.

13. The stack according to claim 1, wherein the tissue paper product in an unfolded state has a GMT tensile strength of at least 70 N/m.

14. The stack according to claim 1, wherein the tissue paper product in an unfolded state has a GMT tensile strength of at least 80 N/m.

15. The stack according to claim 1, wherein the tissue paper product has an absorbency of at least 7 g/g.

16. The stack according to claim 1, wherein the tissue paper product has an absorbency of at least 8 g/g.

17. The stack according to claim 1, wherein the tissue paper product in an unfolded state has a basis weight of less than 80 gsm.

18. The stack according to claim 1, wherein the tissue paper product in an unfolded state has a basis weight of less than 60 gsm.

19. The stack according to claim 1, wherein the tissue paper product in an unfolded state has a thickness in the range between from 0.1 to 3.0 mm, as obtained after removal of the tissue product from the stack.

20. The stack according to claim 1, wherein said tissue paper product is a one-ply tissue paper product and consists of said non-wood tissue ply.

21. The stack according to claim 1, wherein the non-wood cellulose pulp fibres contain at least 15% hemicellulose.

22. The stack according to claim 1, wherein the non-wood cellulose pulp fibres contain no more than 15% lignin.

23. The stack according to claim 1, wherein the non-wood cellulose pulp fibres have an average fibre length of less than 1700 μm.

24. The stack according to claim 1, wherein the non-wood cellulose pulp fibres have an average fibre length of less than 1200 μm.

25. The stack according to claim 1, wherein the non-wood cellulose pulp fibres have an average fibre length of less than 900 μm.

26. The stack according to claim 1, wherein the non-wood cellulose fibres have a breaking length of more than 3000 m.

27. The stack according to claim 1, wherein the non-wood cellulose fibres have a breaking length/average fibre length ratio of more than 3.7.

28. The stack according to claim 1, wherein the non-wood cellulose fibres have a breaking length/average fibre length ratio of more than 4.0.

29. The stack according to claim 1, wherein the non-wood cellulose fibres have a breaking length/average fibre length ratio of more than 4.5.

30. The stack according to claim 1, wherein the non-wood cellulose pulp fibres are derived from a member of the Pocacea family, such as from wheat straw, rice straw, barley straw, oat straw, rye grass, costal Bermuda grass, Arundo donax, miscanthus, bamboo, bagasse from sugar cane, and/or sorghum.

31. The stack according to claim 1, wherein the non-wood cellulose pulp fibres are derived from a member of the Cannabaceae family, such as from hemp and/or hop.

32. The stack according to claim 1, wherein the non-wood cellulose pulp fibres are agricultural waste or byproduct, such as derived from agricultural waste or byproduct of the Pocacea family and/or Cannabaceae family such as exemplified in the above, including agricultural waste or byproduct from wheat straw, rice straw, barley straw, oat straw, rye grass, bagasse from sugar cane, hemp or hop and/or wherein the non-wood cellulose pulp fibres are derived from agricultural waste or byproduct such as banana harvest residue (belongs to the family Musaceae), pineapple residue (belongs to the family Bromeliaceae), nut shell waste, bagasse from agave, hop residue and/or corn stover.

33. The stack according to claim 1, wherein the non-wood cellulose pulp fibres are derived from kenaf (belongs to the family Malvaceae), switchgrass, succulents, alfalfa (belongs to the family Fabaceae), flax straw (belongs to the family Linaceae), palm fruits (Elaeis or Arecaceae), and/or avocado (Lauraceae).

34. The stack according to claim 1, wherein said non-wood tissue ply or plies comprises said non-wood cellulose pulp fibres in an amount of at least 15% by dry weight.

35. The stack according to claim 1, wherein said non-wood tissue ply or plies comprises said non-wood cellulose pulp fibres in an amount of at least 20% by dry weight.

36. The stack according to claim 1, wherein said non-wood tissue ply or plies comprises said non-wood cellulose pulp fibres in an amount of less than 70% by dry weight.

37. The stack according to claim 1, wherein said non-wood tissue ply or plies comprises said non-wood cellulose pulp fibres in an amount of less than 60% by dry weight.

38. The stack according to claim 1, wherein said non-wood tissue ply further comprises wood pulp fibres, such as hardwood cellulose pulp fibres and/or softwood cellulose pulp fibres.

39. The stack according to claim 1, wherein said non-wood tissue ply comprises wood pulp fibres in an amount such that the wood pulp fibre amount plus the non-wood fibre amount constitutes 100% dry weight of the non-wood tissue ply.

40. The stack according to claim 38, wherein the hardwood/softwood dry weight proportion of the wood pulp fibres in said non-wood tissue ply is less than 95/5.

41. The stack according to claim 38, wherein the hardwood/softwood dry weight proportion of the wood pulp fibres in said non-wood tissue ply is less than 90/10.

42. The stack according to claim 38, wherein the hardwood/softwood dry weight proportion of the wood pulp fibres in said non-wood tissue ply is less than 80/20.

43. The stack according to claim 1, wherein said non-wood cellulose pulp fibres are present throughout the non-wood tissue ply or plies.

44. The stack according to claim 1, wherein said non-wood tissue ply or plies comprises two or more layers, and at least one layer comprises non-wood fibres.

45. The stack according to claim 1, wherein a portion or all non-wood cellulose pulp fibres are never-dried non-wood cellulose pulp fibre.

46. The stack according to claim 1, comprising softwood cellulose pulp fibres and wherein a portion or all softwood cellulose fibres are never-dried softwood cellulose pulp fibres.

47. The stack according to claim 1, comprising hardwood cellulose pulp fibres and wherein a portion or all hardwood cellulose fibres are never-dried hardwood cellulose pulp fibres.

48. The stack according to claim 1, the tissue paper product being for personal hygiene, such as toilet paper, hand wipes, paper napkins, facial wipes, handkerchiefs or the tissue paper product being a kitchen towel or industrial wipe.
